(19) United States
(12) Patent Application Publication
(10) Pub. No.: US 2007/0009857 A1
(43) Pub. Date: Jan. 11, 2007

(54) Method and device for whitening teeth

(76) Inventors: Graham K. Philp JR., Naples, FL (US); Damon Brown, Boston, MA (US); Tim Diasti, Clearwater, FL (US)

Correspondence Address: SHLESINGER, ARKWRIGHT & GARVEY LLP, 1420 KING STREET, SUITE 600, ALEXANDRIA, VA, 22314, US

(21) Appl. No.: 11/412,076

(22) Filed: Apr. 27, 2006

Related U.S. Application Data
(60) Provisional application No. 60/675,089, filed on Apr. 27, 2005.

(51) Int. Cl. A61C 5/00

(52) U.S. Cl. 433/217.1; 424/53

(57) ABSTRACT

Method rapidly whitens teeth by using whitening compound containing an oxidizing agent, such as carbamide peroxide, hydrogen peroxide, sodium chlorite, and/or chlorine dioxide. Sonic device emits sonic waves directly to the tooth, transfers the sonic waves through a medium which may be a mist, an encapsulated liquid, a solid, a sponge, or any combination. Device may have a heat source which has controlled temperature of 1°-3° F. to increase the temperature of the tooth whitening compound. Sonic device sonic energy emission to whitening compound applied to teeth, and temperature increase, increases the kinetics, and speeds up the tooth whitening process. A pH adjusting agent included in the whitening compound or directly applied to the teeth may be a pre-treatment rinse, or be via a coating in an encapsulated bag, or within a moistened sponge-like material for releasing onto teeth when the sponge material is pressed against teeth.

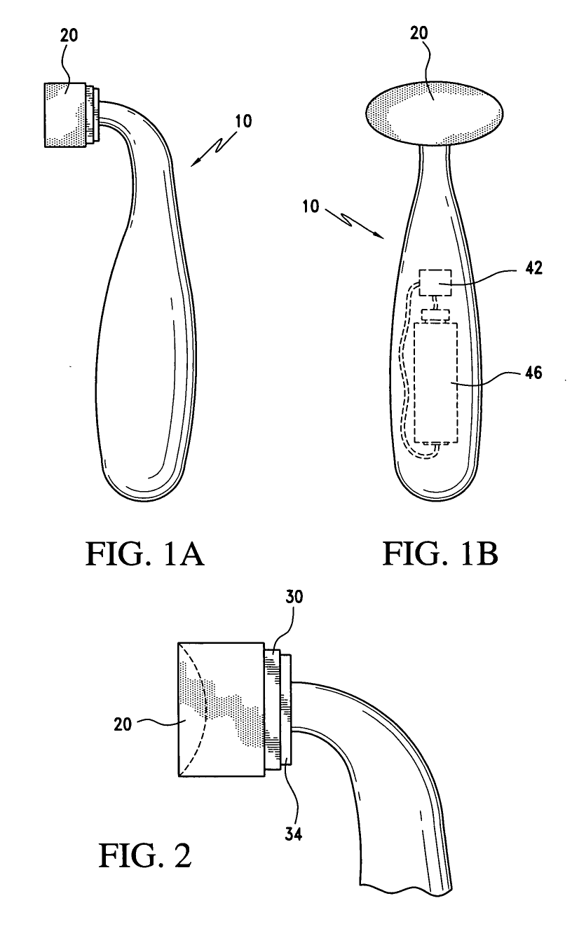

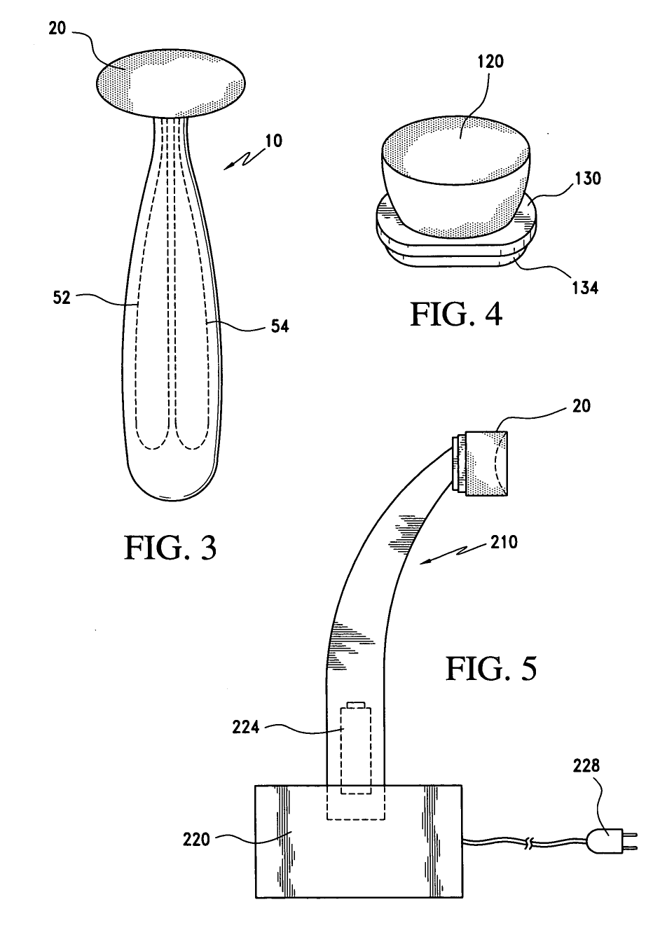

### FIELD OF THE INVENTION

The invention relates to a method of whitening teeth that will achieve effective tooth whitening results, and that may be used by the consumer. In particular, the invention relates to a system including a device which emits sonic waves, a whitening formula, which is contained in a disposable cartridge, containing an oxidizing agent, and a pH adjusting agent which raises the pH on the tooth surface. Also included in the invention is a source of increasing the temperature on the tooth whitening compound from 1-30° F. Also included in the invention are attachments geared at the enhancement of tooth whitening, such as, a dental floss attachment with a whitening compound and a tooth brush attachment configured to remove extrinsic tooth stains.

### BACKGROUND OF THE INVENTION

Natural tooth structures which are affected by stains are the enamel (dentin), and the thin layer on the enamel surface, the acquired pellicle. Tooth enamel is predominately formed from an inorganic substance, hydroxyapalite crystals, along with approximately 5% organic materials, predominately collagen; the balance are inorganic materials including hydroxyapalite crystals. The acquired pellicle is a proteinaceous layer on the surface of tooth enamel. These are the tooth structures which are responsible for the stained appearance of natural teeth. Teeth can become discolored with age, blood, amalgam restorations, antibiotics such as tetracycline, substances in food, beverages, and tobacco and salivary fluid.

Tooth stains are generally classified as either extrinsic or intrinsic depending on whether the stain is on the surface of the tooth, within the acquired pellicle or within the tooth structure itself within the enamel or dentin.

Extrinsic staining of the acquired pellicle can occur from foods or compounds, which contain tannins and other polyphenolic chemicals on the surfaces of the teeth.

Intrinsic staining, on the other hand, occurs when chromogens and pre-chromogens penetrate the enamel and dentin and become tightly bound to the tooth structure. Intrinsic staining can occur when blood or amalgam products leach into the enamel and dentin. Intrinsic staining is not removed by mechanical methods of tooth cleaning and generally requires the use of chemicals, for example strong oxidizing agents such as hydrogen peroxide that can penetrate into the tooth structure to effect a change in the light absorptivity of the stain chromogen and or the solubility of the chromogen.

The desire for whiter, lighter teeth is considered to be desirable and cosmetic in today's society. Tooth bleaching is generally accomplished by gels, pastes, or liquids which contain an oxidizing agent such as hydrogen peroxide. The products from the breakdown of hydrogen peroxide, the oxygen free radicals, attack the chromogen molecules, making them colorless and/or water soluble, making the tooth appear lighter and brighter.

The most commonly-used oxidizing agent is hydrogen peroxide from carbamide peroxide which is mixed with an anhydrous viscous carrier containing glycerin and/or propylene glycol and/or polyethylene glycol. When in contact with water, carbamide peroxide dissociates into urea and hydrogen peroxide. The hydrogen peroxide in the presence of water, then dissociates into water and the oxygen frees radical species. It is these species highly reactive oxygen anions, which react with the stain molecule making the stain more water soluble transparent or both. This phenomenon is responsible for teeth appearing lighter and brighter—hence tooth whitening.

There are several delivery systems to deliver the oxidizing agent to the surfaces of the teeth. A common approach is to have a dental professional construct a custom tray made from a cast of an impression of a patient's teeth. The oxidizing agent in a gel is dispensed into the tray by the patient and the tray is worn over the teeth intermittently for a period of two weeks to several months. This approach can be cumbersome and uncomfortable for the patients to wear the bleaching trays and also can cause tooth sensitivity in approximately 50% of the patients. Tooth sensitivity is believed to be caused by dehydrating the teeth, resulting from movement of fluid from through the dentinal tubules that is sensed by nerve endings within the tooth. The carriers, glycerin and propylene glycol and polyethylene glycol, draw fluids toward them and therefore can contribute to tooth sensitivity often experienced by patients wearing a bleaching tray.

Another approach is to incorporate the oxidizing agent in a strip and have the patient wear the strip intermittently over a period of two weeks. Besides taking excessive time to obtain results, this approach also has the disadvantage of being awkward for patients to wear, and many patients wearing the strips experience tooth sensitivity. Further, the strips have an inherent problem of contacting the teeth only on the facial surfaces, as opposed to the difficult to contact interproximal surfaces, between the teeth, where most of the staining occurs.

Another approach is to simply paint on the oxidizing agent, carbamide peroxide or hydrogen peroxide, directly on the teeth. In products with gels containing glycerin and/or propylene glycol or polyethylene glycol, tooth sensitivity can occur, and these gels can be easily removed from the tooth surfaces by the lips and tongue which significantly reduces their effectiveness.

One successful approach (U.S. Pat. No. 6,517,350) which overcomes the problem of the lips and tongue removing the directly applied oxidizing agent, dissolves the carbamide peroxide in alcohol with a resin. After the whitening agent is directly applied to the teeth, the alcohol is allowed to evaporate away and the resin and oxidizing agent remain as a film or precipitate which can remain in the tooth surface for approximately 20 minutes. When the saliva contacts the teeth the peroxide is released in a relatively strong concentration thus eliminating the need to wear a custom bleaching tray. This product contains no glycerin or propylene glycol or polyethylene glycol and tooth sensitivity is virtually non-existent with significant whitening results. This product is simple and easy to use.

To overcome the problem of taking excessive time to whiten teeth, manufacturers developed an approach to whiten teeth in the dental office in approximately one hour “power bleaching.” These systems generally use an oxidizing agent in high concentrations, hydrogen peroxide of 35% or higher, which is directly applied to the teeth in the dental office by the dentist or supervision of the dentist by the dental hygienist. Due to the high concentration of oxidizing agents contained in these in-office products, they can be hazardous to the patient if not handled carefully.

The patient's soft tissues—gingiva, lips and other soft tissues—must be protected prior to the application of these high concentration oxidization agents. This is usually accomplished by covering the soft tissues with a polymerizable resin that is shaped to conform to the gingival contours and subsequently cured by a high intensity light source. Isolating the soft tissues can also be accomplished by a rubber-dam. These in office “power bleaching” systems are expensive and can be time consuming for the dental practitioners. Further patients often have an uncomfortable experience with sensitive teeth and burning gums following and during these procedures.

To overcome the problems inherent in the in office “power bleaching” systems there is a need for a relatively inexpensive, rapid bleaching system which is a consumer-based system.

Consumers desire whiter, lighter teeth with a system which is inexpensive, easy to apply and requiring less time and fewer applications, capable of whitening the teeth very rapidly without monotonous repetitive applications, without harming the tooth enamel, dentin or pulp without discomfort or sensitivity.

There is a need to offer consumers improved compositions and devices for whitening teeth that are capable of whitening teeth rapidly with few applications.

### OBJECTS AND SUMMARY OF THE INVENTION

It is an object of the invention to provide a tooth-whitening method, and device that overcome the drawbacks of prior art methods, systems, and devices.

It is a further object of the invention to provide a tooth whitening system, which provides a more rapid and efficient whitening of the teeth than previous systems.

It is yet another object of the invention to provide a tooth whitening system, which is self-regulated and avoids overheating of a patient's teeth being whitened.

Another object of this invention is to provide a tooth whitening system, which is accelerated by heat and efficiencies in chemistry and uses sonic waves which the consumer can use at home, thereby being more cost-effective than other in-office rapid whitening systems.

It is a further object of this invention to use a solution or gel with the use and concentration of an oxidizing compound that will not harm or irritate the patient's tissues making it better and more comfortable for the user.

It is yet another object of this invention to use a sonic device which effects a heat increase of the tooth whitening compound by 1° -30° F. either directly on the surface of the tooth or within the outer tooth structure of 1-2 mm, of the tooth structure, with or without the use of light and photosensitive compounds for producing the slight increase in temperature.

It is yet a further object of this invention to use chemicals and pH adjusting agents to increase the efficiency and effectiveness of the oxygen anion species.

It is a further object of the invention to use pH adjusting agents to produce hydronium ions which will physically respond to the sonic waves and increase the efficiency of the tooth whitening process.

The invention is based on adding to the intellectual advances of using heat to increase the kinetics of tooth whitening, and using efficiencies in chemistry to increase the amount and effectiveness of the oxidizing free radicals. This invention in addition uses sonic waves to agitate the whitening composition and break the stain molecules into smaller pieces which speeds up the efficacy of the whitening process. Also included in this invention is an agent which specifically adjusts the pH at the tooth surface to promote and increase the breakdown of peroxide thus producing more oxygen free radicals species along with hydronium ions, OH—, which are very reactive oxidizing species ultimately resulting in a rapid tooth whitening system which the consumer can use at home without harming mouth tissues or causing irritation or tooth sensitivity. It is anticipated that an inexpensive consumer based, whitening system is created to enable consumers to have whiter, lighter teeth in the convenience of their homes with significantly less time and significantly fewer repetitive applications; e.g., 15-20 minute whitening with 3 or 4 applications.

It is a further object of the invention to use attachments on the device having sonic settings, and which attachments are used to enhance the whitening of teeth, i.e. a dental floss attachment which contains a whitening compound and emits the desired sonic energy that when used will remove interproximal tooth staining, and a tooth brush attachment which emits the desired sonic energy to break down tooth stains.

The invention achieves rapid tooth whitening by using a whitening compound containing an oxidizing agent, such as carbamide peroxide, hydrogen peroxide, sodium chlorite, and/or chlorine dioxide. A sonic device is likewise provided that emits sonic waves directly to the tooth, transferring the sonic waves through a medium which may be a mist, an encapsulated liquid, a solid, a sponge, or any combination. The invention also includes a device or system having a heat source which has controlled temperature of 1°-30° F. to increase the temperature of the tooth whitening compound. Also the invention includes a pH adjusting agent which can be included in the whitening compound or directly applied to the teeth either by way of a pre-treatment rinse or via coating an encapsulated bag, or within a moistened sponge-like material which is released onto the teeth when the sponge material is pressed against the teeth. This sponge is connected directly to the sonic device.

The sonic device will emit sonic energy to the whitening compound that is applied to the teeth with an increase of temperature from 1°-30° C., thereby increasing the kinetics of the tooth whitening process and increasing the energy within the system thereby speeding up the whitening process.

### BRIEF DESCRIPTION OF THE DRAWINGS

FIG. IA shows a side view of an embodiment of the invention and in FIG. IB a front view of the embodiment of the invention of FIG. IB is shown; in this FIG. I embodiment a detachable sponge head, and a transducer are illustrated;

FIG. II is a side view of the disposable head of the sonic teeth whitening device of FIG. I, illustrating a metal transducer disposed near to the sponge head;

FIG. III is a front view of the sonic teeth whitening device according to the invention showing the reservoirs for holding on or more whitening solutions, such as a solution in a first reservoir and a gel in a second reservoir;

FIG. IV is a front perspective view of a liquid applicator, such as the sponge attachment, according to the invention, and into which liquid applicator the liquid and/or gel are dispensed for being applied to the user's teeth; and

FIG. V illustrates another embodiment of the invention in which the sonic tooth whitening device is provided with a battery charger base including a conventional converter which may be plugged into household current.

### DETAILED DESCRIPTION OF THE INVENTION

These embodiments are set forth to describe and illustrate the invention, but are not intended to be self limiting. One embodiment of the invention achieves rapid tooth whitening by using a tooth whitening compound and using a sonic device.

The tooth whitening compound will include a surfactant to enable the whitening formula to spread evenly and thoroughly coat the tooth surface, a disinfectant to inhibit the bacteria which produce peroxidases, enzymes which destroy peroxides, a pH adjusting agent to raise the pH to approximately 7.0-9.0 on the surface of the tooth. An increase in the pH drives the breakdown of peroxide to the right producing more oxygen free radical species which are the primary species responsible for tooth whitening—converting an insoluble chromogen into soluble transparent chromogen. The pH adjusting agent will also form hydronium ions which are also highly reactive species which can contribute to whitening and are energized by sonic waves. Also in the tooth whitening compound is a chemical known as a phase transfer catalyst which enhances the efficiency of the whitening process by transporting the oxygen free radical directly to the chromogen and releasing the oxygen free radical directly to the stain. The phase transfer catalyst with the pH adjusting agents allows a safer lower concentration of peroxide to be effective.

The whitening compound is applied though a disposable cartridge with a sponge applicator head. The whitening compound can also be a direct application whitening solution which is either directly applied or applied in a pen device. The whitening formula will contain approximately 5% active hydrogen peroxide dissolved in ethanol along with a resin which will leave a sticky film on the surface of the teeth when the alcohol is allowed to evaporate away enabling the peroxide to stay on contact with the teeth during the procedure.

The sonic device may be a hand held device 10 with a transducer producing approximately 3-5 kHz. The end of the device can have a fluid applicator 20, such as a disposable sponge attachment. The sponge can be imbibed with the whitening formula by applying it directly from bottle. See FIGS. IA and IB.

The sonic device 30 may have a disposable head or applicator 20 which may be a sponge like material. The disposable head will be easily attached to the sonic device and the metal transducer will be directly behind the sponge applicator. A mechanism is included which will slightly warm the metal transducer to 1-30° F. See FIG. II.

Once the sponge is attached the devise will heat the solution and force the whitening compound through the sponge head allowing the oxidizing agent to be applied to the user's teeth.

The moistened sponge or rubber head is then applied to the facial surfaces of the anterior teeth and the sonic device is activated releasing sonic energy to the whitening system along with a slightly heated tooth whitening compound. The transducer will be applied to the teeth for several minutes. The consumer will repeat this procedure a few times to achieve their desired whitening result. The sonic device will be either battery operated or rechargeable to allow sufficient energy to the system. Appropriate circuitry and wiring for the (battery) power source may be provided, as will be readily apparent to a person having ordinary skill in the art. The battery may be user-serviceable (e.g., replaceable) or non-user-serviceable depending on the intended use.

The whitening formula can have a slightly abrasive compound such as silica (e.g., silicon dioxide) which will polish the tooth surface. The whitening formula can also contain a compound used to sooth gums, provide fluoride, and/or kill bacteria that cause bad breath.

Another embodiment of the invention would involve a direct application of the whitening compound to the tooth using a paint-on application, such as a pen-device. The disposable sponge attachment will be embodied with a gel which contains the pH adjusting agent, the phase transfer catalyst, and a disinfectant. The sponge attachment would then be designed to have enough material for one complete treatment (i.e.3 applications, 5 minutes each), after which the sponge may be disposed of.

Another embodiment of the invention is to use liquid hydrogen peroxide in a gel state. A separate liquid in a vial or bottle (which may be stored separately from the hand-held device) may have the pH adjusting agent, a disinfectant, a phase transfer catalyst, and a very mild abrasive. These solutions can be provided in an instrument which would go into the sonic device. The sonic device would have a pump to extrude the liquid pH adjusting agent on the teeth surfaces followed by extruding the gel containing the hydrogen peroxide. FIG. III. The pump may be a push button type pump, such as in a tooth paste dispenser or non-aerosol dispenser, or may be pressurized by the user squeezing a portion of the body of the device. Both may be selected, sized, and configured so that the user dispenses a controlled amount of pH adjusting agent or oxidizing agent.

By providing separate reservoirs, the two (2) constituents or agents may be stored and released individually. The one agent may be the pH adjusting agent, and the other agent in the other reservoir may be the oxidizing agent. This feature may be provided in addition to, or instead of, the temperature increase provided by the sonic device.

It is likewise contemplated that there may be a scenario in which the attachment at the end of the sonic device may be smaller covering only a single of few teeth. FIG. IV.

Whitening Formula

| | | | % by |
|---|---|---|---|
| Product Ingredient | INCI Name | | Weight |
| Ethyl Alcohol 190 | Alcohol | 0.00-95% | 73.12 |
| PEG 300 | Polyethylene Glycol | .001-25% | 1.40 |
| Synthetic Resin | Methyl Hydrogenated | .001-15% | 0.47 |
| (Hercolyn D) | Rosinate | | |
| Peroxydone Hydrogen | PVP Hydrogen | .001-45% | 24.19 |
| Peroxide | Peroxide | | |
| SF 1188A GE Silicone | PEG/PPG-20/15 | .001-5% | 0.47 |
| Polyether | Dimethicone | | |
| Flavoring—Peppermint | Metha Piperita | .001-5% | 0.20 |
| Oil | (Peppermint) Oil | | |
| Flavoring—Aspartame* | Aspartame | .001-5% | 0.15 |
| TOTAL | | | 100% |

While this invention has been described as having a preferred design, it is understood that it is capable of further modifications, and uses and/or adaptations of the invention and following in general the principle of the invention and including such departures from the present disclosure as come within the known or customary practice in the art to which the invention pertains, and as may be applied to the central features hereinbefore set forth, and fall within the scope of the invention or limits of the claims appended hereto.

1. A method of whitening a tooth, comprising:
a) providing a tooth whitening compound to a surface of a user's tooth to be whitened; and
b) applying sonic waves to the tooth whitening compound to sufficiently agitate the tooth whitening compound to speed up the whitening process.

2. Method as in claim 1, wherein:
a) heat is applied to the tooth whitening compound to sufficiently increase the temperature of the tooth whitening compound to speed up the whitening process.

3. Method as in claim 1, wherein:
a) the temperature increase is in a range of 1°-30° F.

4. Method as in claim 3, wherein:
a) the applying of the sonic waves to the tooth whitening compound is performed by a hand-held sonic wave generating device.

5. Method as in claim 2, wherein:
a) the applying of the sonic waves to the tooth whitening compound is performed by a hand-held sonic wave generating device.

6. Method as in claim 1, wherein:
a) the applying of the sonic waves to the tooth whitening compound is performed by a hand-held sonic wave generating device.

7. Method as in claim 6, wherein:
a) an attachment for transmitting the sonic waves is provided on the hand-held sonic wave generating device; and
b) the attachment is configured for conforming to a surface of a user's tooth to be whitened.

8. Method as in claim 6, wherein:
a) an attachment for transmitting the sonic waves is provided on the hand-held sonic wave generating device; and
b) the attachment includes a portion configured for applying a flowable whitening compound to a surface of a user's tooth to be whitened.

9. Method as in claim 8, wherein:
a) the flowable whitening compound includes hydrogen peroxide.

10. Method as in claim 2, wherein:
a) the flowable whitening compound includes hydrogen peroxide.

11. Method as in claim 1, wherein:
a) the flowable whitening compound includes hydrogen peroxide.

12. Method as in claim 11, wherein:
a) the whitening compound includes an agent which specifically adjusts the pH at the tooth surface to promote and increase the breakdown hydrogen peroxide.

13. Method as in claim 12, wherein:
a) the whitening compound includes one of carbamide peroxide, hydrogen peroxide, sodium chlorite, and chlorine dioxide.

14. Method as in claim 2, wherein:
a) the whitening compound includes an agent which specifically adjusts the pH at the tooth surface to promote and increase the breakdown hydrogen peroxide.

15. Method as in claim 1, wherein:
a) the whitening compound includes an agent which specifically adjusts the pH at the tooth surface to promote and increase the breakdown hydrogen peroxide.

16. Method as in claim 15, wherein:
a) the whitening compound includes one of carbamide peroxide, hydrogen peroxide, sodium chlorite, and chlorine dioxide.
